(19) United States
(12) Patent Application Publication
(10) Pub. No.: US 2023/0232402 A1
(43) Pub. Date: Jul. 20, 2023

(54) CHANNEL STATE INFORMATION REPORT TYPE CONFIGURATION

(71) Applicant: QUALCOMM Incorporated, San Diego, CA (US)

(72) Inventors: Yu ZHANG, San Diego, CA (US); Hao XU, Beijing (CN); Chenxi HAO, Beijing (CN); Qiaoyu LI, Beijing (CN); Liangming WU, Beijing (CN); Min HUANG, Beijing (CN); Kangqi LIU, San Diego, CA (US); Chao WEI, Beijing (CN)

(21) Appl. No.: 18/001,214

(22) PCT Filed: Aug. 6, 2020
(86) PCT No.: PCT/CN2020/107354

§ 371 Date: Dec. 8, 2022

(51) Int. Cl. H04W 72/21; H04W 72/02

(52) U.S. Cl. CPC H04W 72/21; H04W 72/02

(57) ABSTRACT

Various aspects of the present disclosure generally relate to wireless communication. In some aspects, a user equipment UE) may receive a channel state information (CSI) report configuration, wherein the CSI report configuration identifies a plurality of CSI report types. The UE may transmit a CSI report, associated with a first CSI report type of the plurality of CSI report types, with information indicating a second CSI report type of the plurality of CSI report types. Numerous other aspects are provided.

### FIELD OF THE DISCLOSURE

Aspects of the present disclosure generally relate to wireless communications and to techniques and apparatuses for channel state information report type configuration.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes: receiving a channel state information (CSI) report configuration, wherein the CSI report configuration identifies a plurality of CSI report types; and transmitting a CSI report, associated with a first CSI report type of the plurality of CSI report types, with information indicating a second CSI report type of the plurality of CSI report types.

In some aspects, a method of wireless communication performed by a base station includes: transmitting, to a UE, a CSI report configuration that identifies a plurality of CSI report types; receiving, from the UE, a first CSI report, associated with a first CSI report type of the plurality of CSI report types, with information indicating a second CSI report type of the plurality of CSI report types; and transmitting, to the UE and after receiving the first CSI report, an indication of a particular CSI report type that the UE is to use for a second CSI report.

In some aspects, a UE for wireless communication includes: a memory; and one or more processors operatively coupled to the memory, the memory and the one or more processors configured to: receive a CSI report configuration, wherein the CSI report configuration identifies a plurality of CSI report types; and transmit a CSI report, associated with a first CSI report type of the plurality of CSI report types, with information indicating a second CSI report type of the plurality of CSI report types.

In some aspects, a base station for wireless communication includes: a memory; and one or more processors operatively coupled to the memory, the memory and the one or more processors configured to: transmit, to a UE, a CSI report configuration that identifies a plurality of CSI report types; receive, from the UE, a first CSI report, associated with a first CSI report type of the plurality of CSI report types, with information indicating a second CSI report type of the plurality of CSI report types; and transmit, to the UE and after receiving the first CSI report, an indication of a particular CSI report type that the UE is to use for a second CSI report.

In some aspects, a non-transitory computer-readable medium storing a set of instructions for wireless communication includes: one or more instructions that, when executed by one or more processors of a UE, cause the UE to: receive a CSI report configuration, wherein the CSI report configuration identifies a plurality of CSI report types; and transmit a CSI report, associated with a first CSI report type of the plurality of CSI report types, with information indicating a second CSI report type of the plurality of CSI report types.

In some aspects, a non-transitory computer-readable medium storing a set of instructions for wireless communication includes: one or more instructions that, when executed by one or more processors of a base station, cause the base station to: transmit, to a UE, a CSI report configuration that identifies a plurality of CSI report types; receive, from the UE, a first CSI report, associated with a first CSI report type of the plurality of CSI report types, with information indicating a second CSI report type of the plurality of CSI report types; and transmit, to the UE and after receiving the first CSI report, an indication of a particular CSI report type that the UE is to use for a second CSI report.

In some aspects, an apparatus for wireless communication includes: means for receiving a CSI report configuration, wherein the CSI report configuration identifies a plurality of CSI report types; and means for transmitting a CSI report, associated with a first CSI report type of the plurality of CSI report types, with information indicating a second CSI report type of the plurality of CSI report types.

In some aspects, an apparatus for wireless communication includes: means for transmitting, to a UE, a CSI report configuration that identifies a plurality of CSI report types; means for receiving, from the UE, a first CSI report, associated with a first CSI report type of the plurality of CSI report types, with information indicating a second CSI report type of the plurality of CSI report types; and means for transmitting, to the UE and after receiving the first CSI report, an indication of a particular CSI report type that the UE is to use for a second CSI report.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example of physical channels and reference signals in a wireless network, in accordance with various aspects of the present disclosure

FIG. 4 is a diagram illustrating examples of CSI reports, in accordance with various aspects of the present disclosure.

FIG. 5 is a diagram illustrating an example associated with channel state information report type configuration, in accordance with various aspects of the present disclosure.

FIGS. 6-7 are diagrams illustrating example processes associated with channel state information report type configuration, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

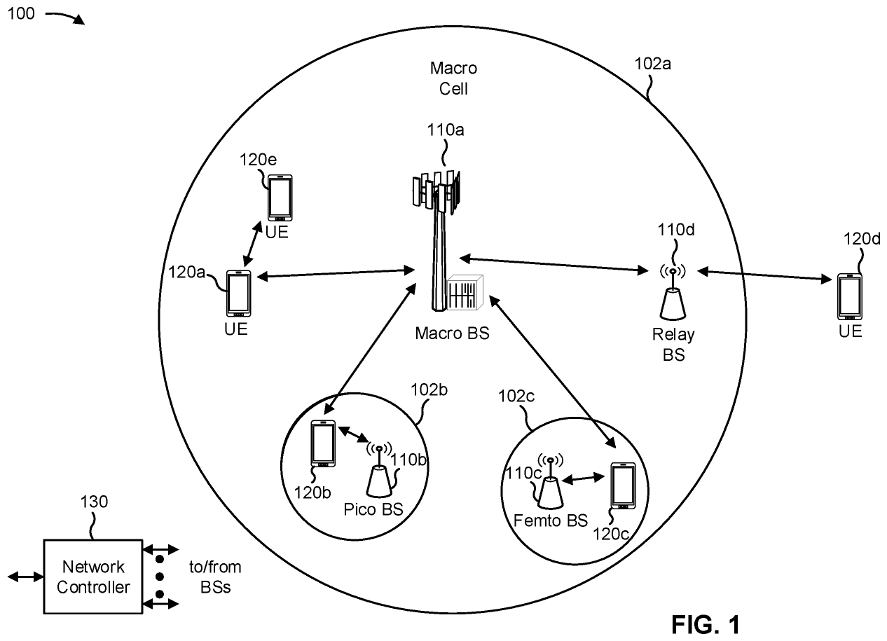

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

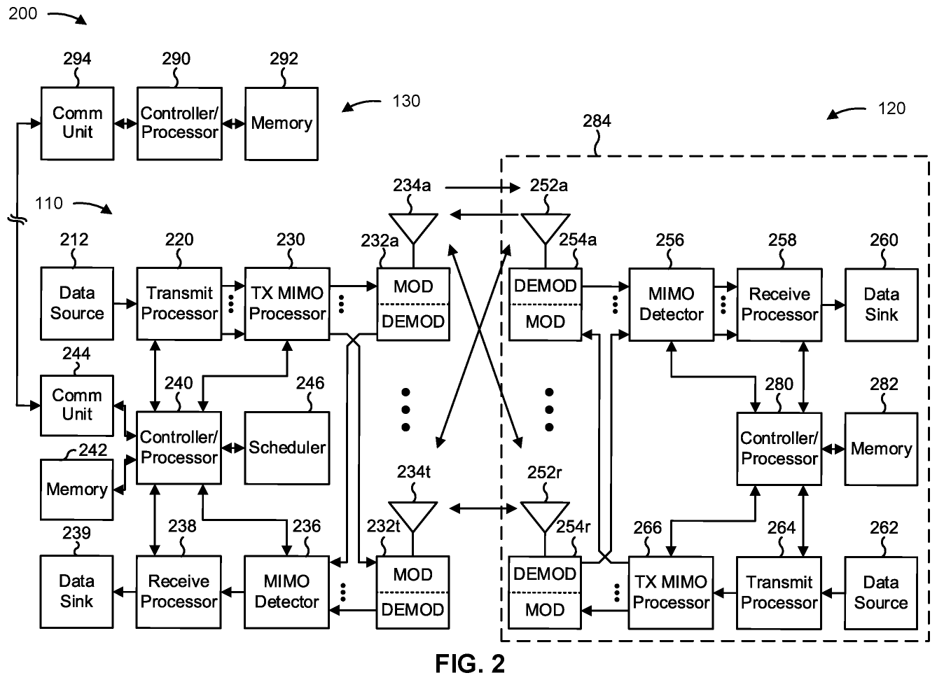

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

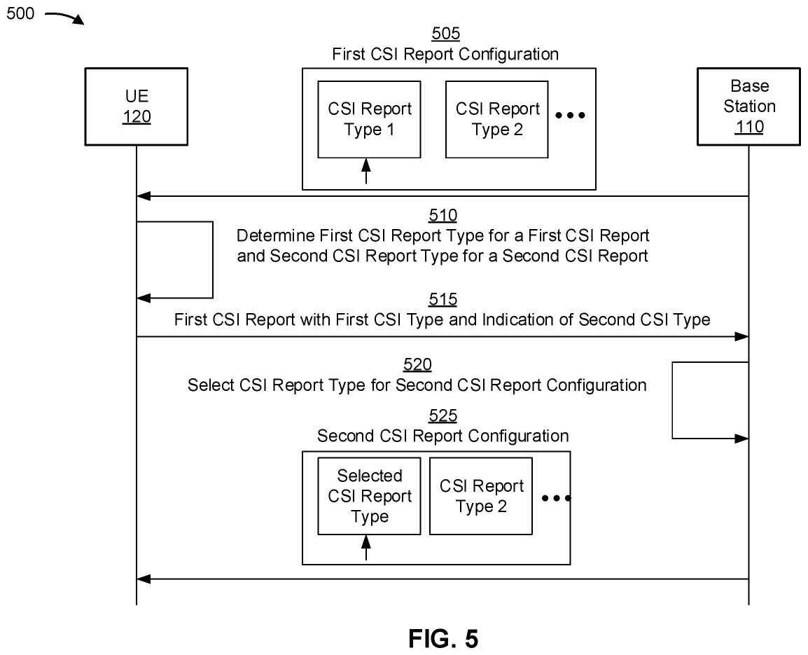

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 5-7.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 5-7.

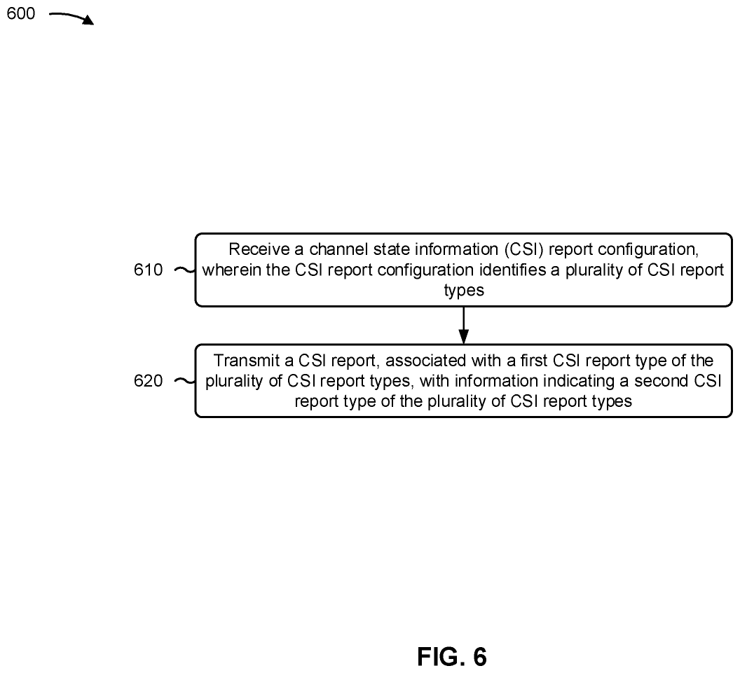

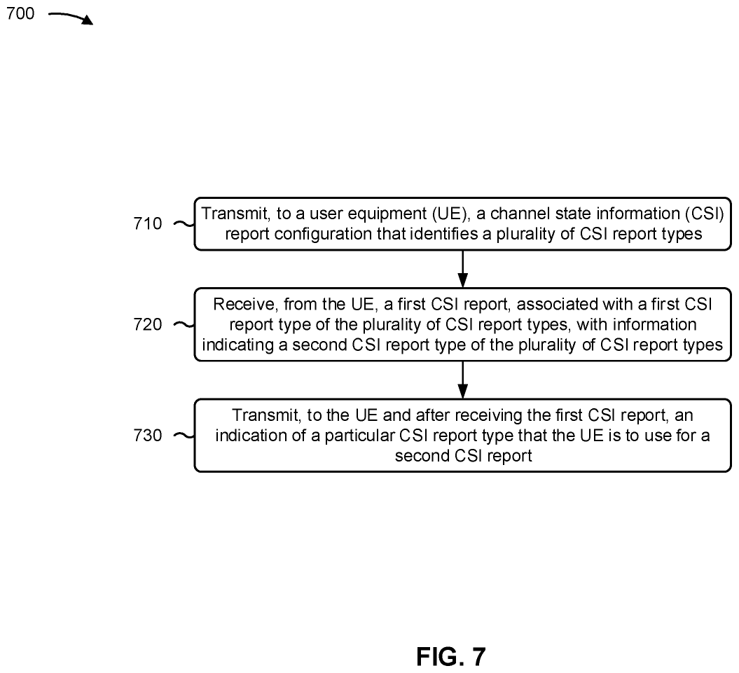

Controller/processor 240 of base station 110, controller/processor 280 of UE 120, and/or any other component(s) of FIG. 2 may perform one or more techniques associated with channel state information report type configuration, as described in more detail elsewhere herein. For example, controller/processor 240 of base station 110, controller/processor 280 of UE 120, and/or any other component(s) of FIG. 2 may perform or direct operations of, for example, process 600 of FIG. 6, process 700 of FIG. 7, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some aspects, executing instructions may include running the instructions, converting the instructions, compiling the instructions, interpreting the instructions, and/or the like.

In some aspects, UE 120 may include means for receiving a channel state information (CSI) report configuration, wherein the CSI report configuration identifies a plurality of CSI report types; means for transmitting a CSI report, associated with a first CSI report type of the plurality of CSI report types, with information indicating a second CSI report type of the plurality of CSI report types, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for transmitting, to a UE (e.g., the UE 120), a CSI report configuration that identifies a plurality of CSI report types; means for receiving, from the UE, a first CSI report, associated with a first CSI report type of the plurality of CSI report types, with information indicating a second CSI report type of the plurality of CSI report types; means for transmitting, to the UE, an indication of a particular CSI report type, selected based at least in part on the information indicating the second CSI report type, that the UE is to use for a second CSI report, and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

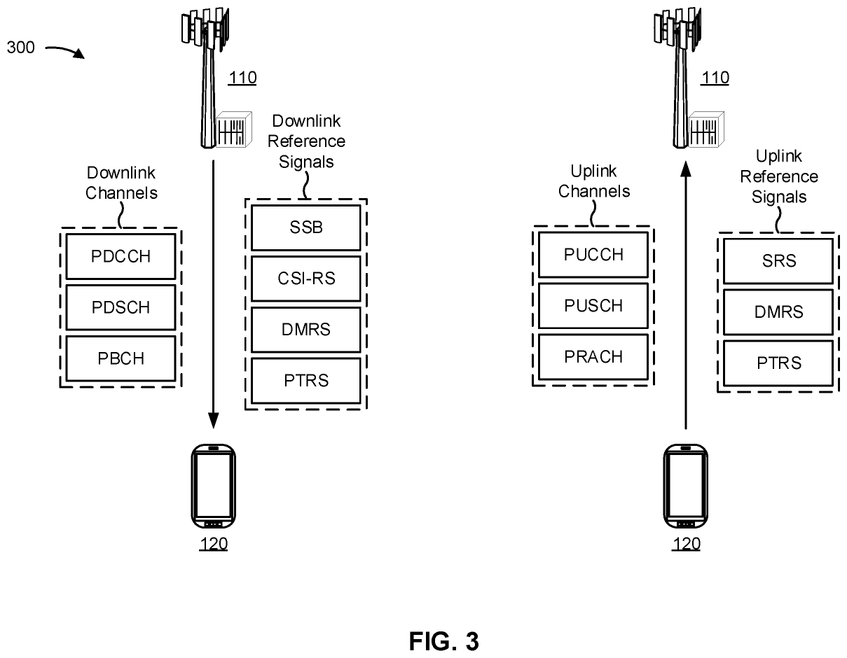

FIG. 3 is a diagram illustrating an example 300 of physical channels and reference signals in a wireless network, in accordance with various aspects of the present disclosure. As shown in FIG. 3, downlink channels and downlink reference signals may carry information from a base station 110 to a UE 120, and uplink channels and uplink reference signals may carry information from a UE 120 to a base station 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel estimation parameters to the base station 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The base station 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

As indicated above, FIG. 3 is provided as an example. Other examples may differ from what is described with regard to FIG. 3.

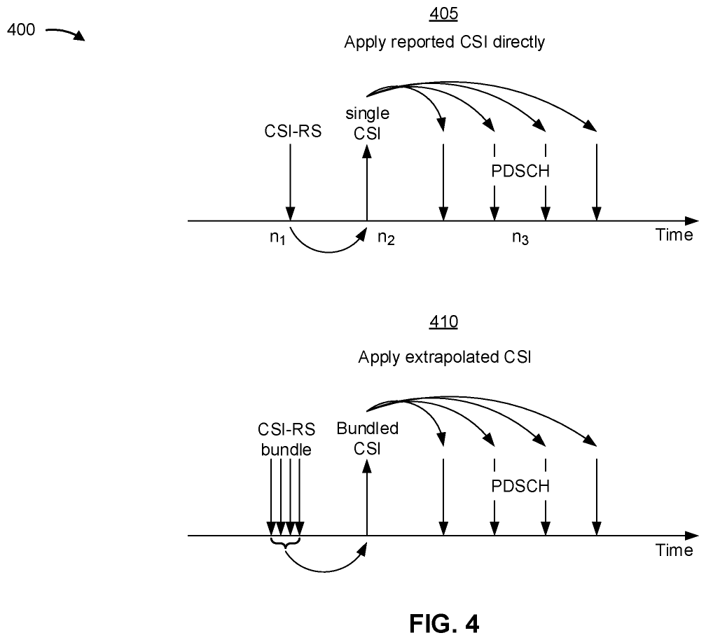

FIG. 4 is a diagram illustrating examples 400 of CSI reports, in accordance with various aspects of the present disclosure. As shown in FIG. 4, the examples 400 include a UE in communication with a base station. The UE and the base station may be in communication with one another in a wireless network, which communication may include an uplink and a downlink.

As described above in connection with FIG. 3, the UE may perform channel estimation and may report one or more channel estimation parameters to the base station in a CSI report, so that the base station may select transmission parameters for downlink communications to the UE. Various CSI report types exist for reporting the one or more channel estimation parameters to the base station. CSI report types may include: a CSI report type which may be used to report one or more channel estimation parameters that are based at least in part on one or more instantaneous measurements of a channel taken at a given time, sometimes referred to as a “closed loop CSI report type”; a CSI report type which may be used to report one or more channel estimation parameters that are based at least in part on a statistical determination with respect to one or more measurements of a channel taken at a given time, sometimes referred to as a “semi-open loop CSI report type”; a CSI report type which may be used to report one or more channel estimation parameters that are based at least in part on a variation of one or more measurements over a period of time, sometimes referred to as a “bundled CSI report type”; and/or the like.

The closed loop CSI report type may be used to report one or more channel estimation parameters that are based at least in part on one or more instantaneous measurements of a channel taken at a given time. The closed loop CSI report type may be used to report channel estimation parameters such as a PMI, RI, CQI (from the UE to the base station), and/or the like. The PMI and RI may be reported by the UE for indicating a precoding matrix for a group of resource blocks which may be associated with a codebook. The CQI, which may be reported by the UE, may be conditioned on the precoding matrix for the group of resource blocks, as indicated by the PMI and RI. For the closed loop CSI report type, the one or more channel estimation parameters, such as PMI, RI, and/or CQI, may be based at least in part on one or more instantaneous measurements of a channel taken at a given time.

As shown by reference number 405, for the closed loop CSI report type, the UE may receive a CSI-RS from the base station at a given time (e.g., n₁). As described in connection with FIG. 3, the CSI-RS may carry information used by the UE for downlink channel estimation. For the closed loop CSI report type, the UE may perform one or more instantaneous measurements of the channel based at least in part on the CSI-RS from the base station at the given time (e.g., n₁). For example, the UE may perform one or more instantaneous measurements of the channel relating to channel estimation parameters such as a PMI, RI, and/or CQI. The UE may report the channel estimation parameters to the base station in a CSI report (e.g., a single CSI report) at a subsequent time (e.g., n₂). The base station, in turn, may apply the channel estimation parameters from the CSI report, of the closed loop CSI report type, to one or more data transmissions (e.g., on the PDSCH) at a further subsequent time (e.g., n₃). For example, the base station 110 may use the CSI report to select transmission parameters for downlink communications to the UE 120, such as a number of transmission layers (e.g., a rank), a precoding matrix (e.g., a precoder), a modulation and coding scheme (MCS), a refined downlink beam (e.g., using a beam refinement procedure or a beam management procedure), and/or the like.

The closed loop CSI report type may be of a first type (e.g., closed loop CSI report type 1) or a second type (e.g., closed loop CSI report type 2). The closed loop CSI report type 1 may involve a smaller payload for the CSI report which may be associated with channel estimation parameters suitable for coarse beamforming. In some aspects, for the closed loop CSI report type 1, a first MIMO layer of the UE may be mapped to a first DFT beam, a second MIMO layer of the UE may be mapped to a second DFT beam, and so forth. The closed loop CSI report type 2 may involve a larger payload for the CSI report which may be associated with channel estimation parameters suitable for fine beamforming. In some aspects, for the closed loop CSI report type 2, a first MIMO layer of the UE may be mapped to a linear combination of a first set of DFT beams and/or a first set of antenna ports, a second MIMO layer of the UE may be mapped to a linear combination of a second set of DFT beams and/or a second set of antenna ports, and so forth.

The semi-open loop CSI report type may be used to report one or more channel estimation parameters that are based at least in part on a statistical determination with respect to one or more measurements of a channel taken at a given time. The semi-open loop CSI report type may be used to report channel estimation parameters such as an RI, a CQI, a set of precoders, and/or the like. The set of precoders reported by the UE may be conditioned on the RI. The CQI reported by the UE may be conditioned on randomly cycling the set of precoders across precoding resource block groups. For the semi-open loop CSI report type, the one or more channel estimation parameters, such as an RI, a CQI, and/or a set of precoders, may be based at least in part on one or more measurements of a channel taken at a given time.

Referring again to reference number 405, for the semi-open loop CSI report type, the UE may receive a CSI-RS from the base station at a given time (e.g., n₁). As described in connection with FIG. 3, the CSI-RS may carry information used by the UE for downlink channel estimation. For the semi-open loop CSI report type, the UE may then perform one or more measurements of the channel based at least in part on the CSI-RS from the base station (e.g., n₁) to make a statistical determination with respect to the one or more measurements. For example, the UE may perform one or more measurements of the channel relating to channel estimation parameters such as an RI, a CQI, and/or a set of precoders. The UE may make a statistical determination with respect to the one or more measurements to report the channel estimation parameters to the base station in a CSI report (e.g., a single CSI report) at a subsequent time (e.g., n2). The base station, in turn, may apply the channel estimation parameters from the CSI report, of the semi-open loop CSI report type, to one or more data transmissions (e.g., on the PDSCH) at a further subsequent time (e.g., n3). For example, the base station 110 may use the CSI report to select transmission parameters for downlink communications to the UE 120, such as a number of transmission layers (e.g., a rank), a precoding matrix (e.g., a precoder), a modulation and coding scheme (MCS), a refined downlink beam (e.g., using a beam refinement procedure or a beam management procedure), and/or the like.

The bundled CSI report type may be used to report one or more channel estimation parameters that are based at least in part on a variation of one or more measurements over a period of time. The bundled CSI report type may be used to report channel estimation parameters, such as a PMI, an RI, and/or a CQI, and/or the like, in a time domain. For the bundled CSI report type, the UE may receive multiple CSI-RSs from the base station over a period of time, perform multiple measurements with respect to the CSI-RSs, determine the one or more channel estimation parameters based at least in part on performing the multiple measurements, and report the one or more channel estimation parameters to the base station.

As shown by reference number 410, for the bundled CSI report type, the UE may receive multiple CSI-RSs from the base station over a period of time (e.g., a bundle of CSI-RSs or a CSI-RS bundle). As described in connection with FIG. 3, a CSI-RS may carry information used by the UE for downlink channel estimation. For the bundled CSI report type, the UE may perform measurements of the channel relating to channel estimation parameters, over the period of time, based at least in part on the bundle of CSI-RSs from the base station. For example, the UE may perform a first set of measurements relating to channel estimation parameters with respect to a first CSI-RS, a second set of measurements relating to channel estimation parameters with respect to a second CSI-RS, and so forth. The UE may determine a variation of the channel estimation parameters for multiple CSI-RSs, including the first CSI-RS, the second CSI-RS, and/or the like. The UE may report the determined variation of the channel estimation parameters to the base station in a CSI report (e.g., a single bundled CSI report) at a subsequent time. The base station, in turn, may apply the channel estimation parameters from the CSI report, of the bundled CSI report type, to one or more data transmissions (e.g., on the PDSCH) at a further subsequent time. For example, the base station 110 may use the CSI report to select transmission parameters for downlink communications to the UE 120, such as a number of transmission layers (e.g., a rank), a precoding matrix (e.g., a precoder), a modulation and coding scheme (MCS), a refined downlink beam (e.g., using a beam refinement procedure or a beam management procedure), and/or the like.

Some CSI report types may be more accurate than other CSI report types in certain situations. For example, in a situation where the UE is undergoing low physical mobility, the closed loop CSI report type 2, which may be based at least in part on one or more instantaneous measurements of a channel taken at a given time (and which may involve a larger payload for the CSI report), may be preferred because information associated with the CSI report may remain accurate for the channel for a greater duration. In a situation where the UE is undergoing medium physical mobility, the bundled CSI report type, which may be based at least in part on a variation of one or more measurements over a period of time, may be preferred because information associated with the CSI report, though lessening in accuracy with time (e.g., due to a Doppler shift), may be correlated to the channel, thus can be used by a base station to derive transmission parameters for downlink communications at a further subsequent time when the channel is varied. In a situation where the UE is undergoing high physical mobility, the closed loop CSI report type 1, which may be based at least in part on one or more instantaneous measurements of a channel taken at a given time (and which may involve a smaller payload for the CSI report), and/or a semi-open loop CSI report type, which may be based at least in part on a statistical determination with respect to one or more measurements of a channel taken at a given time, may be preferred because information associated with the CSI report may be less accurate and/or more robust to the channel varying (e.g., due to a greater Doppler shift).

The base station selects a CSI report type for the UE and communicates the CSI report type to the UE via a CSI report configuration. The UE, in turn, receives the CSI report configuration, performs a channel estimation, and transmits a CSI report to the base station based at least in part on the CSI report type of the CSI report configuration. However, the base station may not have sufficient information to determine which CSI report type (e.g., closed loop CSI report type 1; closed loop CSI report type 2; semi-open loop CSI report type; bundled CSI report type; and/or the like) may be optimal for the UE. For example, the base station may not have information about mobility of the UE and/or information about the time and/or frequency selectivity of the channel to determine which CSI report type may be optimal for the UE. Although the base station could configure the UE to transmit multiple CSI reports with each CSI report corresponding to a different CSI report type, this may undesirably increase overhead in the uplink from the UE to the base station.

Some techniques and apparatuses described herein enable a UE (e.g., the UE 120) to transmit a CSI report to a base station (e.g., the base station 110) with an indication of a recommended CSI report type. The recommended CSI report type may be based at least in part on one or more parameters determined by the UE 120. The base station 110 may transmit, and the UE 120 may receive, a CSI report configuration identifying multiple CSI report types. In some aspects, the UE 120 may transmit a CSI report, associated with a first CSI report type of the multiple CSI report types, with information indicating a second CSI report type of the multiple CSI report types. The base station 110 may use the CSI report to configure a CSI report type, for one or more subsequent CSI reports from the UE 120, which may be optimal for the UE 120.

As indicated above, FIG. 4 is provided as an example. Other examples may differ from what is described with respect to FIG. 4.

FIG. 5 is a diagram illustrating an example 500 associated with channel state information report type configuration, in accordance with various aspects of the present disclosure. As shown in FIG. 5, the example 500 includes a UE (e.g., the UE 120) in communication with a base station (e.g., the base station 110). The UE 120 and the base station 110 may be in communication with one another in a wireless network (e.g., the wireless network 100), which communication may include an uplink and a downlink.

As shown by reference number 505, the base station 110 may transmit, and the UE 120 may receive, a CSI report configuration (shown in FIG. 5 as a “first CSI report configuration”). The CSI report configuration may identify multiple CSI report types (e.g., closed loop CSI report type 1; closed loop CSI report type 2; semi-open loop CSI report type; bundled CSI report type; and/or the like). For example, as shown in FIG. 5, the CSI report configuration may include information identifying “CSI Report Type 1,” “CSI Report Type 2,” and so forth.

The base station 110 may transmit the CSI report configuration to the UE 120 based at least in part on a trigger event occurring. The trigger event may correspond to the UE 120 connecting to the base station 110, the UE 120 reconnecting to the base station 110, expiration of a timer (e.g., the base station 110 may periodically send the CSI report configuration), when information in an earlier CSI report configuration changes, and/or the like.

In some aspects, the base station 110 may optionally identify a particular CSI report type, of the multiple CSI report types, as a default CSI report type. For example, the base station 110 may identify “CSI Report Type 1” as a default CSI report type (shown in FIG. 5 by an arrow pointing to “CSI report type 1”). In some aspects, the base station 110 may provide information identifying the default CSI report type via a DCI message, a medium access control (MAC) control element (CE), a radio resource control (RRC) configuration message, and/or the like. In some aspects, the base station 110 may provide information identifying the default CSI report type as part of the CSI report configuration. Identifying a particular CSI report type as a default CSI report type may permit the base station 110 to more efficiently determine the CSI report type used in a subsequent CSI report from the UE 120.

As shown by reference number 510, after receiving the CSI report configuration from the base station 110, the UE 120 may determine a first CSI report type for a first CSI report, and may determine a second CSI report type for the first CSI report or for a second CSI report. The first CSI report may correspond to a CSI report that occurs earlier in time than the second CSI report. In other words, the UE 120 may transmit the first CSI report, to the base station 110, before the second CSI report.

The first CSI report type may be one of the multiple CSI report types identified in the CSI report configuration (e.g., closed loop CSI report type 1; closed loop CSI report type 2; semi-open loop CSI report type; bundled CSI report type; and/or the like). The second CSI report type may also be one of the multiple CSI report types identified in the CSI report configuration (e.g., closed loop CSI report type 1; closed loop CSI report type 2; semi-open loop CSI report type; bundled CSI report type; and/or the like). The first CSI report type may correspond to a CSI report type to be used by the UE 120 for a CSI report and the second CSI report type may correspond to a CSI report type that the UE 120 recommends, to the base station 110, to be used for a CSI report (also referred to as a “recommended CSI report type”). In some aspects, the first CSI report type is the same CSI report type as the second CSI report type. In some aspects, the first CSI report type is a different CSI report type from the second CSI report type. In some aspects, the first CSI report type and/or the second CSI report type corresponds to the default CSI report type. In some aspects, neither the first CSI report type nor the second CSI report type corresponds to the default CSI report type.

The UE 120 may determine the first CSI report type and/or the second CSI report type based at least in part on one or more parameters, such as one or more parameters relating to mobility, channel, time, frequency, and/or the like. For example, with respect to mobility, the UE 120 may use a parameter indicating that the UE 120 is undergoing low physical mobility (e.g., mobility that does not satisfy a first threshold) to determine that a closed loop CSI report type 2 may be preferred for the first CSI report type and/or the second CSI report type; that the UE 120 is undergoing medium physical mobility (e.g., mobility that satisfies the first threshold and does not satisfy a second threshold) to determine that a bundled CSI report type may be preferred for the first CSI report type and/or the second CSI report type; or that the UE 120 is undergoing high physical mobility (e.g., mobility that satisfies the second threshold) to determine that a closed loop CSI report type 1 or a semi-open loop CSI report type may be preferred for the first CSI report type and/or the second CSI report type. These are simply examples of parameters and preferred CSI report types that may relate to mobility of the UE 120. In practice, the UE 120 may use any single one of the parameters listed above (e.g., a mobility parameter, a channel parameter, a time parameter, and/or a frequency parameter), any combination of the parameters listed above, or one or more other parameters to determine a preferred CSI report type in a given situation.

In some aspects, the UE 120 may determine CSI report types for the first CSI report type and the second CSI report type based at least in part on referencing a stored list. The stored list may associate CSI report types to the one or more parameters determined by the UE 120. As a result, the UE 120 may reference the stored list to determine the first CSI report type and the second CSI report which may be optimal for the UE 120 in a given situation.

In some aspects, the UE 120 may determine the first CSI report type to be the default CSI report type. For example, when the base station 110 identifies a particular CSI report type as the default CSI report type, the UE 120 may determine the first CSI report type to be the default CSI report type when a size of a payload associated with the second CSI report type is larger than a size of a payload associated with the default CSI report type. In this situation, the first CSI report type and the second CSI report type are different CSI report types. In other words, the UE 120 may determine the first CSI report type to be the default CSI report type when the second CSI report type involves the use of more resources than the default CSI report type.

In some aspects, the UE 120 may determine the first CSI report type to be the second CSI report type (i.e., the recommended CSI report type). For example, the UE 120 may determine the first CSI report type to be the second CSI report type when a size of a payload associated with the second CSI report type is less than or equal to a size of a payload associated with the default CSI report type. In this situation, the first CSI report type and the second CSI report type are the same CSI report type (i.e., the recommended CSI report type). In other words, the UE 120 may determine the first CSI report type to be the second CSI report type when the second CSI report type does not involve the use of more resources than the default CSI report type.

After determining the first CSI report type, the UE 120 may perform one or more measurements of the channel based at least in part on one or more CSI-RSs from the base station 110 for the first CSI report type. For example, when the first CSI report type is the closed loop CSI report type, the UE 120 may perform one or more instantaneous measurements of the channel based at least in part on the CSI-RS from the base station 110 at the given time; when the first CSI report type is the semi-open loop CSI report type, the UE 120 may perform a statistical determination with respect to one or more measurements of the channel based at least in part on the CSI-RS from the base station 110 at the given time; or when the first CSI report type is the bundled CSI report type, the UE 120 may perform measurements of the channel based at least in part on multiple CSI-RSs from the base station 110 over a period of time.

The UE 120 may prepare a CSI report of the first CSI report type that includes information regarding the one or more measurements of the channel. The CSI report may also include an indication of the second CSI report type (i.e., the recommended CSI report type). In some aspects, the indication of the second CSI report type may be provided external to the CSI report.

As shown by reference number 515, the UE 120 may transmit, and the base station 110 may receive, the CSI report of the first CSI report type, and an indication of the second CSI report type. The UE may also identify parameters with respect to the first CSI report type, such as a codebook parameter, a reportQuantity parameter, and/or the like. The UE 120 may select an uplink resource for transmitting the CSI report to the base station 110. In some aspects, the uplink resource selected by the UE 120, and the indication of the second CSI report type, may permit the base station 110 to infer the first CSI report type.

In some aspects, the UE 120 may transmit information explicitly identifying the first CSI report type associated with the CSI report. In this situation, the information explicitly identifying the first CSI report type may permit the base station 110 to directly determine the first CSI report type associated with the CSI report (e.g., the default CSI report type or a same CSI report type as the second CSI report type).

In some aspects, the UE 120 may transmit the CSI report without explicitly identifying the first CSI report type associated with the CSI report. In this situation, the resource allocation selected by the UE 120 and the indication of the second CSI report type may permit the base station 110 to indirectly determine the first CSI report type associated with the CSI report (e.g., the default CSI report type or a same CSI report type as the second CSI report type). In other words, the base station 110 may infer the first CSI report type based at least in part on the uplink resource selected by the UE 120 and the indication of the second CSI report type by the UE 120, without the benefit of an explicit identification of the first CSI report type.

After the UE 120 transmits the CSI report associated with the first CSI report type and the indication of the second CSI report type, the base station 110 may determine the first CSI report type associated with the CSI report. In some aspects, the base station 110 may determine the first CSI report type based at least in part on an explicit indication from the UE 120. In some aspects, the base station 110 may determine the first CSI report type without an explicit indication by the UE 120. For example, the base station 110 may infer the first CSI report type based at least in part on the resource allocation selected by the UE 120 and the indication of the second CSI report type, as described above.

As shown by reference number 520, after the base station 110 determines the first CSI report type associated with the CSI report, the base station 110 may select a CSI report type for a second CSI report configuration. For example, the base station 110 may select the CSI report type based at least in part on information included in the CSI report. In some aspects, the base station 110 may select the CSI report type based at least in part on the information regarding the one or more measurements of the channel. In this situation, the base station 110 may use the information regarding the one or more measurements of the channel to calculate or look up (e.g., in a storage device) the CSI report type for the second CSI report configuration. In some aspects, the base station 110 may select the CSI report type based at least in part on the indication of the second CSI report type (i.e., the recommended CSI report type). In this situation, the base station 110 may use the second CSI report type as the CSI report type for the second CSI report configuration. In some aspects, the base station 110 may use a combination of the information regarding the one or more measurements of the channel and the indication of the second CSI report type to determine, calculate, or look up the CSI report type for the second CSI report configuration.

As shown by reference number 525, after selecting the CSI report type for the second CSI report, the base station 110 may transmit, and the UE 120 may receive, the second CSI report configuration for the UE 120 to use for a second CSI report to the base station 110. The second CSI report configuration may identify the CSI report type selected by the base station 110 as a default CSI type. For example, as shown in FIG. 5, the base station 110 may transmit, and the UE 120 may receive, a second CSI report configuration identifying a “Selected CSI Report Type” (e.g., closed loop CSI report type 1; closed loop CSI report type 2; semi-open loop CSI report type; bundled CSI report type; and/or the like). The base station 110 may identify the “Selected CSI Report Type” as a default CSI report type (shown in FIG. 5 by an arrow pointing to “Selected CSI Report Type”). In some aspects, the CSI report type selected by the base station 110 (e.g., the Selected CSI Report Type) may be the second CSI report type recommended by the UE 120 (e.g., the base station 110 following the recommendation of the UE 120). In some aspects, the CSI report type selected by the base station 110 (e.g., the Selected CSI Report Type) may be a CSI report type that is different than the second CSI report type recommended by the UE 120 (e.g., the base station 110 not following the recommendation of the UE 120).

After receiving the second CSI report configuration from the base station 110, the UE 120 may transmit, and the base station 110 may receive, a second CSI report associated with a CSI report type selected by the base station 110 (e.g., the Selected CSI Report Type). In some aspects, such as when one or more parameters determined by the UE 120 change again, the UE 120 may transmit another indication of a second CSI report type (i.e., another recommended CSI report type), and the process may repeat. As a result, the base station 110 may configure a CSI report type, for one or more subsequent CSI reports from the UE 120, which may be optimal for the UE 120.

The base station 110 and the UE 120 may communicate based at least in part on information in the CSI report. For example, the base station 110 may apply channel estimation parameters, derived from the information regarding the one or more measurements of the channel from the CSI report, to one or more data transmissions (e.g., on the PDSCH) to the UE 120. In other words, the base station 110 may use information in the CSI report to select transmission parameters for downlink communications to the UE 120, such as a number of transmission layers (e.g., a rank), a precoding matrix (e.g., a precoder), a modulation and coding scheme (MCS), a refined downlink beam (e.g., using a beam refinement procedure or a beam management procedure), and/or the like.

As indicated above, FIG. 5 is provided as an example. Other examples may differ from what is described with respect to FIG. 5.

FIG. 6 is a diagram illustrating an example process 600 performed, for example, by a UE, in accordance with various aspects of the present disclosure. Example process 600 is an example where the UE (e.g., UE 120) performs operations associated with channel state information report type configuration.

As shown in FIG. 6, in some aspects, process 600 may include receiving a CSI report configuration, wherein the CSI report configuration identifies a plurality of CSI report types (block 610). For example, the UE (e.g., using antenna 252, demodulator 254, MIMO detector 256, receive processor 258, controller/processor 280, and/or memory 282) may receive a CSI report configuration, wherein the CSI report configuration identifies a plurality of CSI report types, as described above.

As further shown in FIG. 6, in some aspects, process 600 may include transmitting a CSI report, associated with a first CSI report type of the plurality of CSI report types, with information indicating a second CSI report type of the plurality of CSI report types (block 620). For example, the UE (e.g., using antenna 252, transmit processor 264, TX MIMO processor 266, modulator 254, controller/processor 280, and/or memory 282) may transmit a CSI report, associated with a first CSI report type of the plurality of CSI report types, with information indicating a second CSI report type of the plurality of CSI report types, as described above.

Process 600 may include additional aspects, such as any single aspect or any combination of aspects described below and/or in connection with one or more other processes described elsewhere herein.

In a first aspect, transmitting the CSI report comprises transmitting, in connection with the CSI report, information indicating that the CSI report is associated with the first CSI report type.

In a second aspect, alone or in combination with the first aspect, the first CSI report type is a default CSI report type of the CSI report configuration.

In a third aspect, alone or in combination with one or more of the first and second aspects, process 600 includes using the default CSI report type as the first CSI report type when a payload associated with the second CSI report type is larger than a payload associated with the default CSI report type.

In a fourth aspect, alone or in combination with one or more of the first through third aspects, the first CSI report type and the second CSI report type are a same CSI report type.

In a fifth aspect, alone or in combination with one or more of the first through fourth aspects, process 600 includes using the second CSI report type as the first CSI report type when a payload associated with the second CSI report type is less than or equal to a payload associated with a default CSI report type.

In a sixth aspect, alone or in combination with one or more of the first through fifth aspects, process 600 includes selecting a resource allocation for transmission of the CSI report, and wherein transmitting the CSI report comprises transmitting the CSI report using the resource allocation for the CSI report, wherein the resource allocation and the information identifying the second CSI report type permit the first CSI report type associated with the CSI report to be determined.

In a seventh aspect, alone or in combination with one or more of the first through sixth aspects, the resource allocation and the information identifying the second CSI report type enable a determination that the first CSI report type is a default CSI report type of the CSI report configuration.

In an eighth aspect, alone or in combination with one or more of the first through seventh aspects, the resource allocation and the information identifying the second CSI report type enable a determination that the first CSI report type and the second CSI report type are a same CSI report type.

In a ninth aspect, alone or in combination with one or more of the first through eighth aspects, the CSI report configuration does not include information identifying a default CSI report type.

In a tenth aspect, alone or in combination with one or more of the first through ninth aspects, process 600 includes receiving information identifying a particular CSI report type, wherein the particular CSI report type is based at least in part on the information indicating the second CSI report type, and transmitting another CSI report using the particular CSI report type.

In an eleventh aspect, alone or in combination with one or more of the first through tenth aspects, the particular CSI report type is the second CSI report type.

In a twelfth aspect, alone or in combination with one or more of the first through eleventh aspects, process 600 includes using at least one of a UE mobility parameter, a channel parameter, a time parameter, or a frequency parameter to select the second CSI report type.

In a thirteenth aspect, alone or in combination with one or more of the first through twelfth aspects, process 600 includes receiving information indicating a default CSI report type, of the plurality of CSI report types, via a downlink control information message, a medium access control control element, a radio resource control configuration message, or a combination thereof.

In a fourteenth aspect, alone or in combination with one or more of the first through thirteenth aspects, the plurality of CSI report types, identified by the CSI report configuration, includes a first CSI report type configured to track an instantaneous channel state at a given time and provide coarse beamforming, a second CSI report type configured to track an instantaneous channel state at a given time and provide fine beamforming, a third CSI report type configured to track variation of an instantaneous channel state in time, a fourth CSI report type configured to track a statistical channel state in time, or a combination thereof.

In a fifteenth aspect, alone or in combination with one or more of the first through fourteenth aspects, receiving the CSI report configuration comprises identifying one or more parameters for each CSI report type of the plurality of CSI report types.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a base station, in accordance with various aspects of the present disclosure. Example process 700 is an example where the base station (e.g., base station 110) performs operations associated with channel state information report type configuration.

As shown in FIG. 7, in some aspects, process 700 may include transmitting, to a UE, a CSI report configuration that identifies a plurality of CSI report types (block 710). For example, the base station (e.g., using transmit processor 220, TX MIMO processor 230, modulator 232, antenna 234, controller/processor 240, memory 242, and/or scheduler 246) may transmit, to a UE (e.g., UE 120), a CSI report configuration that identifies a plurality of CSI report types, as described above.

As further shown in FIG. 7, in some aspects, process 700 may include receiving, from the UE, a first CSI report, associated with a first CSI report type of the plurality of CSI report types, with information indicating a second CSI report type of the plurality of CSI report types (block 720). For example, the base station (e.g., using antenna 234, demodulator 232, MIMO detector 236, receive processor 238, controller/processor 240, and/or memory 242) may receive, from the UE, a first CSI report, associated with a first CSI report type of the plurality of CSI report types, with information indicating a second CSI report type of the plurality of CSI report types, as described above.

As further shown in FIG. 7, in some aspects, process 700 may include transmitting, to the UE and after receiving the first CSI report, an indication of a particular CSI report type that the UE is to use for a second CSI report (block 730). For example, the base station (e.g., using transmit processor 220, TX MIMO processor 230, modulator 232, antenna 234, controller/processor 240, memory 242, and/or scheduler 246) may transmit, to the UE and after receiving the first CSI report, an indication of a particular CSI report type that the UE is to use for a second CSI report, as described above.

Process 700 may include additional aspects, such as any single aspect or any combination of aspects described below and/or in connection with one or more other processes described elsewhere herein.

In a first aspect, process 700 includes selecting the particular CSI report type based at least in part on the information indicating the second CSI report type, and wherein transmitting the indication of the particular CSI report type comprises transmitting the indication of the particular CSI report type based at least in part on selecting the particular CSI report.

In a second aspect, alone or in combination with the first aspect, receiving the first CSI report comprises receiving, in connection with the first CSI report, information indicating that the first CSI report is associated with the first CSI report type.

In a third aspect, alone or in combination with one or more of the first and second aspects, the first CSI report type is a default CSI report type of the CSI report configuration.

In a fourth aspect, alone or in combination with one or more of the first through third aspects, process 700 includes using the default CSI report type as the first CSI report type when a payload associated with the second CSI report type is larger than a payload associated with the default CSI report type.

In a fifth aspect, alone or in combination with one or more of the first through fourth aspects, the first CSI report type and the second CSI report type are a same CSI report type.

In a sixth aspect, alone or in combination with one or more of the first through fifth aspects, process 700 includes using the second CSI report type as the first CSI report type when a payload associated with the second CSI report type is less than or equal to a payload associated with a default CSI report type.

In a seventh aspect, alone or in combination with one or more of the first through sixth aspects, receiving the first CSI report comprises receiving the first CSI report using a resource allocation for the first CSI report, and further comprising determining the first CSI report type associated with the first CSI report from the resource allocation and the information identifying the second CSI report type.

In an eighth aspect, alone or in combination with one or more of the first through seventh aspects, the resource allocation and the information identifying the second CSI report type enable a determination that the first CSI report type is a default CSI report type of the CSI report configuration.

In a ninth aspect, alone or in combination with one or more of the first through eighth aspects, the resource allocation and the information identifying the second CSI report type enable a determination that the first CSI report type and the second CSI report type are a same CSI report type.

In a tenth aspect, alone or in combination with one or more of the first through ninth aspects, the CSI report configuration does not include information identifying a default CSI report type.

In an eleventh aspect, alone or in combination with one or more of the first through tenth aspects, process 700 includes using at least one of a UE mobility parameter, a channel parameter, a time parameter, or a frequency parameter to select the particular CSI report type.

In a twelfth aspect, alone or in combination with one or more of the first through eleventh aspects, transmitting the CSI report configuration comprises transmitting information indicating a default CSI report type, of the plurality of CSI report types, via a downlink control information message, a medium access control control element, a radio resource control configuration message, or a combination thereof.

In a thirteenth aspect, alone or in combination with one or more of the first through twelfth aspects, the plurality of CSI report types, identified by the CSI report configuration, includes a first CSI report type configured to track an instantaneous channel state at a given time and provide coarse beamforming, a second CSI report type configured to track an instantaneous channel state at a given time and provide fine beamforming, a third CSI report type configured to track variation of an instantaneous channel state in time, a fourth CSI report type configured to track a statistical channel state in time, or a combination thereof.

In a fourteenth aspect, alone or in combination with one or more of the first through thirteenth aspects, transmitting the CSI report configuration comprises transmitting the CSI report configuration to enable the UE to identify one or more parameters for each CSI report type of the plurality of CSI report types.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving a channel state information (CSI) report configuration, wherein the CSI report configuration identifies a plurality of CSI report types; and
transmitting a CSI report, associated with a first CSI report type of the plurality of CSI report types, with information indicating a second CSI report type of the plurality of CSI report types.

2. The method of claim 1, wherein transmitting the CSI report comprises:
transmitting, in connection with the CSI report, information indicating that the CSI report is associated with the first CSI report type.

3. The method of claim 1, wherein the first CSI report type is a default CSI report type of the CSI report configuration, and
further comprising:
using the default CSI report type as the first CSI report type when a payload associated with the second CSI report type is greater than a payload associated with the default CSI report type.

4. The method of claim 1, wherein the first CSI report type and the second CSI report type are a same CSI report type, and
further comprising:
using the second CSI report type as the first CSI report type when a payload associated with the second CSI report type is less than or equal to a payload associated with a default CSI report type.

5. The method of claim 1, further comprising:
selecting a resource allocation for transmission of the CSI report; and
wherein transmitting the CSI report comprises:
transmitting the CSI report using the resource allocation for the CSI report, wherein the resource allocation and the information identifying the second CSI report type permit the first CSI report type associated with the CSI report to be determined.

6. The method of claim 5, wherein the resource allocation and the information identifying the second CSI report type enable a determination that:
the first CSI report type is a default CSI report type of the CSI report configuration, or
the first CSI report type and the second CSI report type are a same CSI report type.

7. The method of claim 1, wherein the CSI report configuration does not include information identifying a default CSI report type.

8. The method of claim 1, further comprising:
receiving information identifying a particular CSI report type, wherein the particular CSI report type is based at least in part on the information indicating the second CSI report type; and
transmitting another CSI report using the particular CSI report type, and
wherein the particular CSI report type is the second CSI report type.

9. The method of claim 1, further comprising:
using at least one of a UE mobility parameter, a channel parameter, a time parameter, or a frequency parameter to select the second CSI report type.

10. The method of claim 1, further comprising:
receiving information indicating a default CSI report type, of the plurality of CSI report types, via a downlink control information message, a medium access control control element, a radio resource control configuration message, or a combination thereof.

11. The method of claim 1, wherein the plurality of CSI report types, identified by the CSI report configuration, includes:
a first CSI report type configured to track an instantaneous channel state at a given time and provide coarse beamforming,
a second CSI report type configured to track an instantaneous channel state at a given time and provide fine beamforming,
a third CSI report type configured to track variation of an instantaneous channel state in time,
a fourth CSI report type configured to track a statistical channel state in time, or
a combination thereof.

12. The method of claim 1, further comprising:
identifying one or more parameters for each CSI report type of the plurality of CSI report types.

13. A method of wireless communication performed by a base station, comprising:
transmitting, to a user equipment (UE), a channel state information (CSI) report configuration that identifies a plurality of CSI report types;
receiving, from the UE, a first CSI report, associated with a first CSI report type of the plurality of CSI report types, with information indicating a second CSI report type of the plurality of CSI report types; and
transmitting, to the UE and after receiving the first CSI report, an indication of a particular CSI report type that the UE is to use for a second CSI report.

14. The method of claim 13, further comprising:
selecting the particular CSI report type based at least in part on the information indicating the second CSI report type; and
wherein transmitting the indication of the particular CSI report type comprises:
transmitting the indication of the particular CSI report type based at least in part on selecting the particular CSI report.

15. The method of claim 13, wherein receiving the first CSI report comprises:
receiving, in connection with the first CSI report, information indicating that the first CSI report is associated with the first CSI report type.

16. The method of claim 13, wherein the first CSI report type is a default CSI report type of the CSI report configuration, and
further comprising:
using the default CSI report type as the first CSI report type when a payload associated with the second CSI report type is greater than a payload associated with the default CSI report type.

17. The method of claim 13, wherein the first CSI report type and the second CSI report type are a same CSI report type, and
further comprising:
using the second CSI report type as the first CSI report type when a payload associated with the second CSI report type is less than or equal to a payload associated with a default CSI report type.

18. The method of claim 13, wherein receiving the first CSI report comprises:
receiving the first CSI report using a resource allocation for the first CSI report,
and further comprising:
determining the first CSI report type associated with the first CSI report from the resource allocation and the information identifying the second CSI report type.

19. The method of claim 18, wherein the resource allocation and the information identifying the second CSI report type enable a determination that:
the first CSI report type is a default CSI report type of the CSI report configuration, or
the first CSI report type and the second CSI report type are a same CSI report type.

20. The method of claim 13, wherein the CSI report configuration does not include information identifying a default CSI report type, and
further comprising:
using at least one of a UE mobility parameter, a channel parameter, a time parameter, or a frequency parameter to select the particular CSI report type.

21. The method of claim 13, wherein transmitting the CSI report configuration comprises:
transmitting information indicating a default CSI report type, of the plurality of CSI report types, via a downlink control information message, a medium access control control element, a radio resource control configuration message, or a combination thereof.

22. The method of claim 13, wherein the plurality of CSI report types, identified by the CSI report configuration, includes:
a first CSI report type configured to track an instantaneous channel state at a given time and provide coarse beamforming,
a second CSI report type configured to track an instantaneous channel state at a given time and provide fine beamforming,
a third CSI report type configured to track variation of an instantaneous channel state in time,
a fourth CSI report type configured to track a statistical channel state in time, or
a combination thereof.

23. The method of claim 13, wherein transmitting the CSI report configuration comprises:
transmitting the CSI report configuration to enable the UE to identify one or more parameters for each CSI report type of the plurality of CSI report types.

24. A user equipment (UE) for wireless communication, comprising:
a memory; and
one or more processors coupled to the memory, the one or more processors configured to:
receive a channel state information (CSI) report configuration, wherein the CSI report configuration identifies a plurality of CSI report types; and
transmit a CSI report, associated with a first CSI report type of the plurality of CSI report types, with information indicating a second CSI report type of the plurality of CSI report types.

25. The UE of claim 24, wherein the one or more processors, when configured to transmit the CSI report, are configured to:
transmit, in connection with the CSI report, information indicating that the CSI report is associated with the first CSI report type.

26. The UE of claim 24, wherein the first CSI report type is a default CSI report type of the CSI report configuration, and
wherein the one or more processors are configured to:
use the default CSI report type as the first CSI report type when a payload associated with the second CSI report type is larger than a payload associated with the default CSI report type.

27. The UE of claim 24, wherein the first CSI report type and the second CSI report type are a same CSI report type, and
wherein the one or more processors are configured to:
use the second CSI report type as the first CSI report type when a payload associated with the second CSI report type is less than or equal to a payload associated with a default CSI report type.

28. A base station for wireless communication, comprising:
a memory; and
one or more processors coupled to the memory, the one or more processors configured to:
transmit, to a user equipment (UE), a channel state information (CSI) report configuration that identifies a plurality of CSI report types;
receive, from the UE, a first CSI report, associated with a first CSI report type of the plurality of CSI report types, with information indicating a second CSI report type of the plurality of CSI report types; and
transmit, to the UE and after receiving the first CSI report, an indication of a particular CSI report type that the UE is to use for a second CSI report.

29. The base station of claim 28, wherein the one or more processors are further configured to:
select the particular CSI report type based at least in part on the information indicating the second CSI report type; and
wherein the one or more processors, when configured to transmit the indication of the particular CSI report type, are configured to:
transmit the indication of the particular CSI report type based at least in part on selecting the particular CSI report.

30. The base station of claim 28, wherein the one or more processors, when configured to receive the first CSI report, are configured to:
receive, in connection with the first CSI report, information indicating that the first CSI report is associated with the first CSI report type.
